(19) United States
(12) Patent Application Publication
(10) Pub. No.: US 2021/0403281 A1
(43) Pub. Date: Dec. 30, 2021

(54) HOLOGRAPHIC ELEVATOR CONTROL BOX

(71) Applicant: Yesar Electronics Technology (Shanghai) Co., Ltd., Shanghai (CN)

(72) Inventor: Jinghua SHI, Shanghai (CN)

(21) Appl. No.: 17/020,408

(22) Filed: Sep. 14, 2020

(30) Foreign Application Priority Data
Jun. 29, 2020 (CN) 202021234705.7

(51) Int. Cl. B66B 1/52; B66B 1/34; B66B 1/50

(52) U.S. Cl. CPC B66B 1/52; B66B 1/3446; B66B 2201/4646; B66B 2201/4638; B66B 2201/4623; B66B 1/50

(57) ABSTRACT

A holographic elevator control box, which comprises a housing and a first cover plate. The surface of the housing is fixedly connected with a first cover plate through bolts. The inside of the housing is provided with a holographic optical module. The holographic optical module is fixedly connected with the housing. The surface of the holographic optical module group is fixedly connected with a screen. The surface of the first cover plate is fixedly connected with a main board. The screen is connected with the main board through wires, and the top of the housing is installed with an induction module. The holographic elevator control box can address cross infection so that when using the elevator with the device, the interaction between the person and the elevator can be realized by clicking, sliding and other gestures on the image generated by the equipment in the air.

### CROSS-REFERENCE

This application claims the benefit of priority to CN Utility Model Patent Application No. 202021234705.7, filed Jun. 29, 2020, the contents of which are herein incorporated by reference into the Detailed Description herein below.

### TECHNICAL FIELD

Examples relate to the technical field of elevator control boxes, in particular to a holographic elevator control box.

### TECHNICAL BACKGROUND

The current elevator control box mainly includes: physical buttons, physical display screen and elevator integrated design, which can be realized by clicking physical buttons during human-computer interaction. The original contact-free holographic imaging technology is a kind of optical reconstruction and reconstruction using optical principles. A touchable holographic image is generated in the air. This technology is an emerging technology, mainly used in vehicles, display, etc.

Human hands or elevator buttons are full of bacteria and germs, so when people click they cause cross-infection. In particular, the novel coronavirus in 2020 has even more manifested the importance of non-contact in public places. For this, we propose a holographic elevator control box for contact-free operation.

### SUMMARY

The purpose of the present invention is to provide a holographic elevator control box capable of avoiding cross-infection, which aims to solve the problems raised in the background art.

In order to achieve the above objective, the present invention provides the following technical solutions: a holographic elevator control box, comprising a housing and a first cover, the surface of the housing is fixedly connected with the first cover by bolts, and a holographic optical mold is set inside the housing. The holographic optical module is fixedly connected to the housing, the surface of the holographic optical module is fixedly connected with a screen, the surface of the first cover plate is fixedly connected with a main board, and the screen and the main board are connected by a wire. A sensing module is installed on the top of the housing, and an adapter board is installed on the surface of the first cover board beside the main board, and the adapter board is connected to the main board by wires.

Preferably, the optical module device includes a variety of optical films, lenses and other optical equipment, and the image formed in the screen is imaged in the air through a holographic optical module.

Preferably, the sensing module includes a gesture sensor and a sensor cover plate, the top of the housing is fixedly connected with a sensor cover plate by bolts, a gesture sensor is installed on the surface of the sensor cover plate, and the gesture sensor is connected to the main board through a wire connection.

Preferably, a microphone and a speaker are fixedly connected to the surface of the first cover plate, and both the microphone and the speaker are connected to the main board through wires.

Preferably, the surface of the housing away from the first cover is provided with heat dissipation holes and a plurality of mounting and fixing holes.

Preferably, the main board communicates with the elevator through an adapter board.

Compared with the prior art, the beneficial effects are:

The whole structure is an elevator holographic control box equipment. The main board is energized and automatically runs the elevator control program that has been written, and is displayed on the screen in the equipment through data communication. The light emitted by the screen is transformed by the holographic optical module to absorb impurities. Astigmatism, control ghosting, adjust brightness, optical lens, etc., the gesture sensor is connected with the main board through a wire, recognizes the gesture action in a certain area, and sends it back to the main board. The main board will recognize the gesture action as an operation command similar to a touch screen for human-computer interaction. Since the position of the image generated by the optical reconstruction in the air is fixed, the recognition area of the gesture sensor and the air imaging are overlapped to achieve the effect of operating the screen in the air. By clicking and other operations on the image generated in the air, select the elevator floor, transfer the information to the main board, and send it to the elevator control system through the transfer board to realize the door opening and closing control of the elevator, and the selection control function of the destination floor to avoid touching the physical buttons, thereby avoiding cross-infection or people passing through the microphone produces sound, voice control, and transmits the signal to the main board, which is precisely controlled by the elevator control system.

### BRIEF DESCRIPTION OF DRAWINGS

FIG. 1 is a schematic diagram of the housing structure of an example embodiment of the holographic elevator control box;

FIG. 2 is a schematic diagram of the structure of the first cover plate of the holographic elevator control box;

FIG. 3 is a schematic diagram of the structure of the induction module of the holographic elevator control box;

FIG. 4 is an exploded view of the holographic elevator control box;

FIG. 5 is a schematic diagram of the flow structure of a holographic elevator control box method in accordance with an example embodiment.

In the figure: 1. Housing; 2. First cover; 3. Mounting holes; 4. Holographic optical module; 5. Screen; 6. Gesture sensor; 7. Sensor cover; 8. Main board; 9. Adapter Board; 10. Loudspeaker; 11. Heat dissipation hole; 12. Microphone; 13. Sensor module.

### DETAILED DESCRIPTION

The following will clearly and completely describe the technical solutions in the embodiments of example embodiments in conjunction with the accompanying drawings in the example embodiments. Obviously, the described embodiments are only a part of the example embodiments, not all examples. Based on the example embodiments, all other embodiments obtained by those of ordinary skill in the art without creative work shall fall within the protection scope.

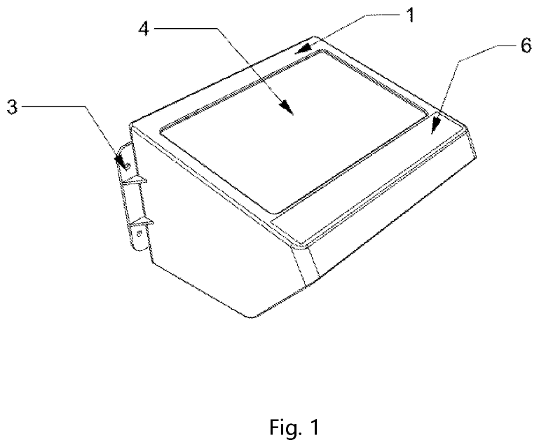

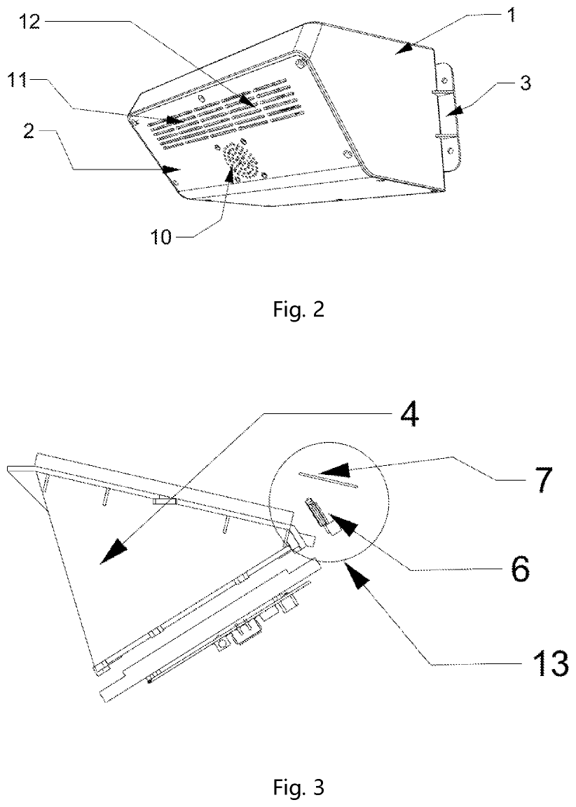

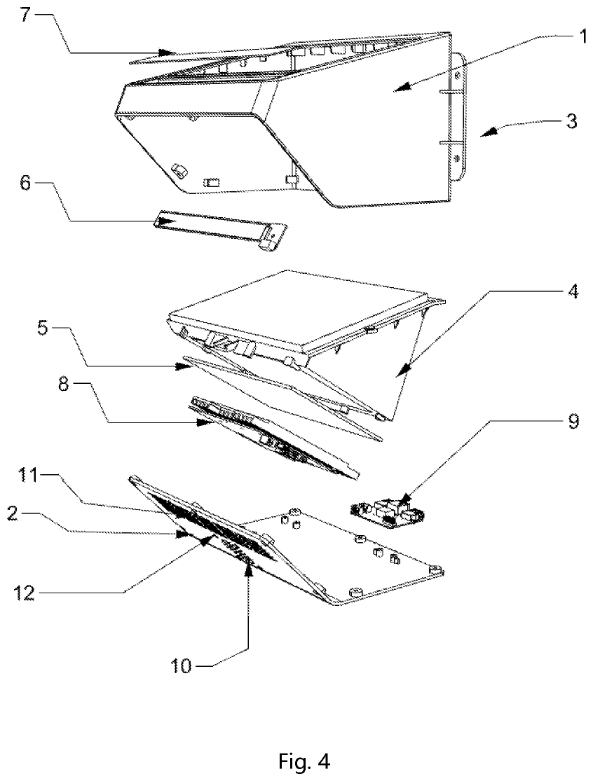

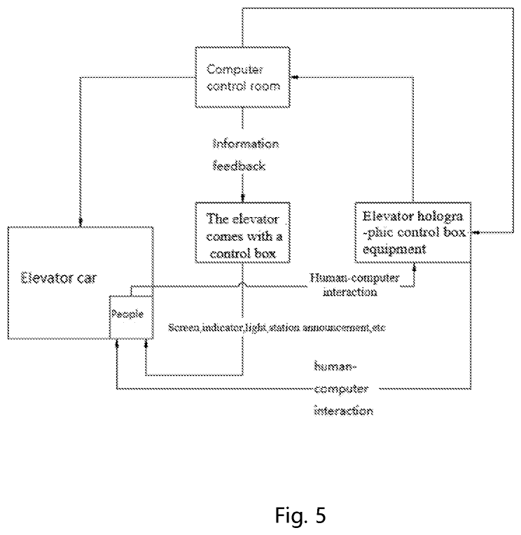

Please refer to FIGS. 1 and 5, a holographic elevator control box, including a housing 1, a first cover plate 2, the surface of the housing 1 is fixedly connected with a first cover plate 2 by bolts, and a holographic optical mold is set inside the housing 1, the holographic optical module 4 is fixedly connected to the housing 1, a screen 5 is fixedly connected to the surface of the holographic optical module 4, a main board 8 is fixedly connected to the surface of the first cover plate 2, and the screen 5. The screen 5 is connected to the main board 8 by a wire, the top of the casing 1 is equipped with a sensing module 13, the surface of the first cover 2 is located next to the main board 8 and an adapter board 9 is installed, and the adapter board 9 and the main board 8 pass through wires for connection, the adapter board 9 is similar in structure to the adapter board 9 used in the existing drip control system, and its working principle is the same.

The holographic optical module 4 includes various optical films, lenses and other optical equipment. The image formed in the screen 5 is imaged in the air by the holographic optical module 4, which can transform the image on the screen 5 into the air and cooperate with the induction module 13.

The sensing module 13 includes a gesture sensor 6 and a sensor cover plate 7. The top of the housing 1 is fixedly connected with a sensor cover plate 7 by bolts. A gesture sensor 6 is installed on the surface of the sensor cover plate 7. Plate 6 is connected to the main board 8 by wires, which can sense human gestures and combine with the image generated by the holographic optical module 4, so that people can easily recognize and control.

A microphone 12 and a speaker 10 are fixedly connected to the surface of the first cover plate 2. The microphone 12 and the speaker 10 are both connected to the main board 8 through wires. The microphone 12 can better collect the human voice and transmit the signal to the elevator the control system realizes the control of the elevator, and the speaker 10 can facilitate human-computer interaction.

The surface of the housing away from the first cover 2 is provided with a heat dissipation hole 11 and a plurality of mounting and fixing holes 3.

The main board 8 communicates with the elevator through the transfer board 9 to play a connection role, so that the main board 8 is closely connected with the entire elevator control system.

It should be noted that in this article, relational terms such as first and second are only used to distinguish one entity or operation from another entity or operation, and do not necessarily require or imply one of these entities or operations. There is any such actual relationship or order between. Moreover, the terms “include”, “include” or any other variants thereof are intended to cover non-exclusive inclusion, so that a process, method, article or device including a series of elements not only includes those elements, but also includes those that are not explicitly listed other elements, or also include elements inherent to this process, method, article or equipment.

Although the embodiments of the present invention have been shown and described, those of ordinary skill in the art can understand that various changes and modifications can be made to these embodiments without departing from the principle and spirit of the present invention. Substitutions and modifications, the scope of the present invention is defined by the appended claims and their equivalents.

What is claimed is:

1. A holographic elevator control box, comprising:
a housing (1) and a first cover plate (2), wherein a surface of the housing (1) is fixedly connected with a first cover plate (2), wherein the housing (1) is internally provided with a holographic optical module (4), the holographic optical module (4) is fixedly connected with the housing (1), and the surface of the holographic optical module (4) is fixedly connected with a screen (5), a surface of the first cover plate (2) is fixedly connected with a main board (8), the screen (5) is connected with the main board (8) through a first wire, a top of the housing (1) is installed with an induction module (13), the surface of the first cover plate (2) is arranged beside the main board (8), and an adapter board (9) is connected with the main board (8) through a second wire.

2. The holographic elevator control box according to claim 1, wherein the holographic optical module (4) includes a variety of optical films and lenses and other optical equipment, and an image formed in the screen (5) is imaged in the air by the holographic optical module (4).

3. The holographic elevator control box according to claim 1, wherein the sensing module (13) includes a gesture sensor (6) and a sensor cover (7), and a top of the housing (1) is fixedly connected to a sensor cover (7), the gesture sensor (6) is installed on a surface of the sensor cover (7), and the gesture sensor (6) is connected with the main board (8) through a third wire.

4. The holographic elevator control box according to claim 1, further comprising a microphone (12) and a speaker (10) which are fixedly connected to the surface of the first cover plate (2), and the microphone (12) and the loudspeaker (10) are connected with the main board (8) through a third wire and a fourth wire, respectively.

5. The holographic elevator control box according to claim 1, wherein the surface of the housing (1) away from the first cover plate (2) is provided with a heat dissipation hole (11) and a plurality of fixing holes (3).

6. The holographic elevator control box according to claim 1, wherein the main board (8) communicates with the elevator through the transfer board (9).
